(19) United States
(12) Patent Application Publication
(10) Pub. No.: US 2009/0104917 A1
(43) Pub. Date: Apr. 23, 2009

(54) Position-finding method in a radiocommunication system, position finding system and device for carrying out said method

(76) Inventors: Nidham Ben Rached, Paris (FR); Thierry Lucidarme, Montigny Le Bretonneux (FR); Gabriel Linden, Villepreux (FR)

Correspondence Address: TROP, PRUNER & HU, P.C., 1616 S. VOSS ROAD, SUITE 750, HOUSTON, TX, 77057-2631, US

(21) Appl. No.: 10/583,580

(22) PCT Filed: Nov. 10, 2004
(86) PCT No.: PCT/EP2004/012738

§ 371 Date: Dec. 8, 2008

(30) Foreign Application Priority Data
Dec. 19, 2003 (FR) 0315084

(51) Int. Cl. H04W 64/00

(52) U.S. Cl. 455/456.1

(57) ABSTRACT

A position-finding method in a radiocommunication system comprising at least one first and one second sub-system and means (34, 35, 36, 39) for finding the position of a mobile terminal (30), wherein the mobile system can communicate and carry out measurements relating to position-finding on each of the first and second sub-systems, and the position finding means for locating the mobile terminal are embodied in such a way that they can take into account certain measurements carried out by the mobile terminal. The inventive method comprises the following steps when the mobile terminal is connected to the first sub-system: measurements relating to position finding on the second sub-system are carried out in the mobile terminal; the measurements thus carried out are transmitted to the first sub-system; and carrying out the measurements in order to find the position of the mobile terminal by taking into account certain measurements, at least those transmitted to the first sub-system.

This invention relates to a method of determining the position in a heterogeneous radiocommunication system. In particular, it relates to determining the position of a mobile terminal in a radiocommunication system comprising two distinct sub-systems.

Numerous position-finding services are known. Within the framework of those services, a position-finding information is generally required, from a client to a position-finding server, for a given mobile terminal. The position-finding information, which is an estimate of the position of the mobile terminal, is determined by the position-finding server on the basis of the measurements carried out by the base stations or, in the case that is more relevant to us below, by the mobile terminal upon a position-finding request. This information is ultimately returned to the client originating the position-finding request.

For example, position-finding services are provided in the second generation (2G) radiocommunication system called GSM (“Global System for Mobile communications”) or in the extension of this system to the transmission of data packets, referred to as GPRS (“General Packet Radio Service”). In particular, these services are described in the technical specification TS 43.059, version 6.2.0, (“Functional stage 2 description of Location Services (LCS) in GERAN”), published in November 2003, by the 3GPP (3^{rd} Generation Partnership Project).

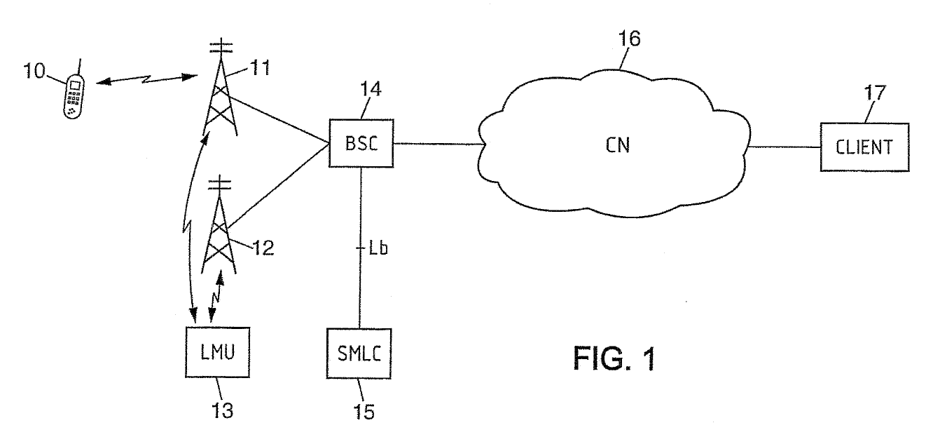

FIG. 1 shows a 2G radiocommunication system capable of implementing such location service. Thus, the system shown comprises two base stations or BTS (“Base Transceiver Station”) 11 and 12, connected to a Base Station Controller or BSC 14, itself connected to a Core Network or CN 16. A mobile terminal 10 is also radio linked to the BTS 11.

The system shown also includes a mobile location centre or SMLC (“Serving Mobile Location Centre”) 15, which may either be integrated into the radio sub-system or work as a stand-alone unit, as shown in FIG. 1, where it is connected to the BSC 14 through an interface Lb. The SMLC implements the terminal 10 location service upon a request from a client 17, which may be internal or external to the radiocommunication system to which terminal 10 is connected. The protocol used between the SMLC and the mobile terminal is the RRLP. In particular, it is used to order the terminal to carry out measurements for position-finding purposes, then returning those measurements to the SMLC for processing, through a radio sub-system. This protocol is defined in the technical specification TS 44.031, version 6.1.0, “Location Services (LCS); Mobile Station (MS)—Serving Mobile Location Centre (SMLC); Radio Resource LCS Protocol (RRLP)”, published in September 2003 by the 3GPP.

Three main position-finding methods can be implemented by the system shown in FIG. 1. The first position-finding method is based on the Timing Advance parameter. The BTS 11, which has a radio link to the terminal 10, measurements a time lag between the reception of a frame from the terminal and a reference time, which enables it to estimate the frame delay between the terminal 10 and the BTS 11. When a Timing Advance measurement is made by the BTS 11 and transmitted to the SMLC 15, the latter can make a rough estimate of the distance between the terminal 10 and the BTS 11, based on said measurement.

A second position-finding method, called E-OTD (“Enhanced Observed Time Difference”), is based on comparative measurements of the time of arrival of frames originating from different BTS. Thus, when the terminal 10 receives a numbered frame from each of the BTS 11 and 12, it notes the OTD time difference between the two receptions. If the BTS 11 and 12 are not synchronized, the RTD (“Real Time Difference”) between the transmissions from these two BTS should also be compensated. To this end, a device called LMU (“Location Measurement Unit”) 13 is provided in the radiocommunication system. The LMU may either be integrated into a BTS of the system or work as a stand-alone unit whose position is clearly identified, as shown in FIG. 1. These different measurements are reported back to the SMLC 15, which is then able to estimate the position of the mobile terminal 10 by subtracting the RTD from the OTD.

Finally, a third position-finding method is based on the GPS (“Global Positioning System”) satellite positioning system. The position of the mobile terminal 10 is then estimated by the SMLC 15 in accordance with the GPS system.

Location services are also provided in the third generation (3G) radiocommunication system called UMTS (“Universal Mobile Telecommunication System”). In particular, these services are described in the technical specification TS 25.305, version 5.7.0, (“User Equipment (UE) positioning in Universal Terrestrial Radio Access Network (UTRAN); Stage 2”), published in September 2003 by the 3GPP.

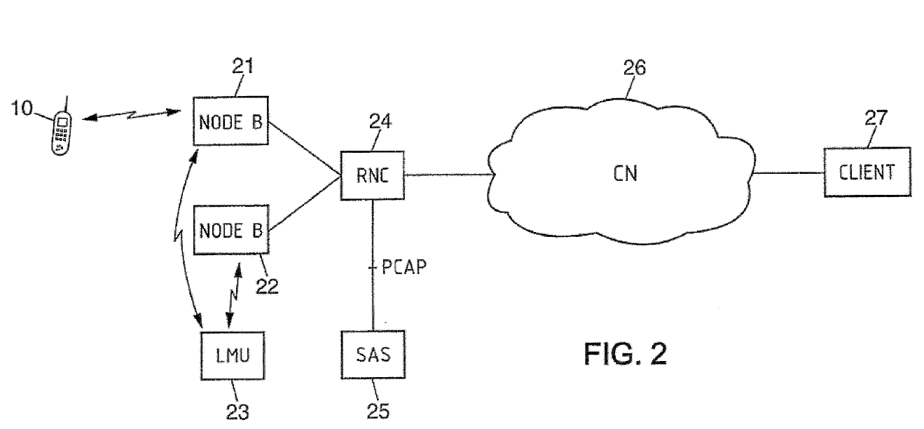

FIG. 2 shows a 3G radiocommunication system capable of implementing such position-finding system. Thus, the system shown comprises, in particular, two base stations or Nodes B 21 and 22, connected to a Radio Network Controller or RNC 24, itself connected to a Core Network or CN 26. A mobile terminal or UE (“User Equipment”) 20 is also connected to the Node B 21 via a radio link.

The system shown also includes a location centre (SMLC), which may be integrated into the radio sub-system or work as a stand-alone unit. The SMLC is then referred to as a SAS (“Stand-Alone SMLC”). A SAS 25 connected to the RNC 24 via a PCAP interface is shown in FIG. 2. The PCAP interface is described in technical specification 25.453, version 6.2.0, “UTRAN lupc interface Positioning Calculation Application Part (PCAP) signaling,” published in September 2003 by the 3GPP.

In this system, the RNC 24 is responsible for implementing the position-finding procedure, upon a request from a client 27 which may be internal or external to the radiocommunication system to which the UE 20 is connected. The SAS 25 is then used as a simple location calculation server, when the calculation is not performed by the RNC 24 itself. The protocol used for the exchanges between the RNC 24, which is then a Serving RNC, and the UE 20 is the RRC protocol, as defined in technical specification TS 25.331, version 5.6.0, “Radio Resource Control (RRC) protocol specification,” published in September 2003 by the 3GPP. In particular, this protocol provides messages for ordering the terminal to carry out measurements for position-finding purposes, as well as for reporting those measurements to the RNC.

In such third generation system, several position-finding methods are also available. For example, a first position-finding method is based on a cell identification or Cell ID. The UE is thus located by knowing the identity of the Node B to which it is linked, since the position or coverage area of the Node B is known. If the UE is not linked to any BTS, meaning that it is not in active mode, the network may then poll it, for example by paging, so that is connected to a Node B. This cell identification may be completed by other measurements, such as the RTT (“Round Trip Time”) measurements that provide an estimate of the roundtrip delay between the UE and its Node B to which it is linked.

A second position-finding method is called OTDOA-IPDL (Observed Time Difference Of Arrival—Idle Period DownLink). Measurements of reception time differences are made by the UE 20 from several Nodes B (for example, 21 and 22), and corrected to compensate for the lack of synchronization between the transmissions from these Nodes B by a LMU unit 23, as in the E-OTD method used in the 2G (second generation) or 2.5G (extension of second generation to the transmission of data packets) systems, as described above. Each Node B may also introduce idle periods (IPDL), on an optional basis, in order to improve the quality of the reception of adjoining Nodes B by the UE, and to avoid the glare caused to the UE by a nearby Node B from which it receives a signal with a high field-strength level. Thus the OTDOA measurements are improved when the IPDL is used, to the detriment, however, of the quality of the communications in progress, which may be interrupted during the idle periods of some Nodes B.

Finally, a third position-finding method is based on GPS type measurements made by the UE, as in the 2G case described above.

A multimode UE capable of working in several systems, for example, 2G or 2.5G and 3G (third generation), can carry out measurements when ordered to do so by the radiocommunication system to which it is connected at a given time. If, at the given time, the UE is linked to a 2G BTS, it may carry out make 2G measurements upon receiving the order from a SMLC. If, at another time, the UE is linked to a 3G Node B, it may carry out 3G type measurements upon receiving the order from its SRNC (Serving RNC).

However, a location determination based on measurements carried out by such UE with its connecting sub-system (2G-2.5G or 3G) is not always optimal. This is especially sensitive in a heterogeneous radiocommunication system that includes a 2G (or 2.5G) sub-system and a 3G sub-system, as both sub-systems have different service areas. For example, the 2G coverage is quasi-uniform, while the 3G coverage is more disparate. A UE located in the 3G coverage area will thus report measurements for a 3G type location determination, while a 2G type location determination would have benefited from the higher density of radio equipment, which would have led to a more accurate location determination. In addition, in the event that the 3G position-finding method implemented used the IPDL functionality described above, the implementation of a 2G position-finding method would have avoided the presence of idle periods on the part of the Node B received by the UE with the strongest signal, and the degradation of the link, or even the temporary interruption of the communication resulting therefrom.

Conversely, the determination of the location of a UE linked to a 2G BTS, but also located near a 3G Node B from which it receives a slightly weaker signal, can be less accurate than if it had been carried out in 3G. In fact, the accuracy of the location determination, which is a random value, is inversely proportional to \sqrt{B.τ}, where B represents the pass-band of the system, and τ represents an observation period. Since the 3G pass-band is approximately 15 times greater than the 2G pass-band, the 3G location determination is approximately 4 times more accurate than the 2G location determination, for the same observation period. With quasi-equivalent radio conditions in both sub-systems, a 3G location determination is thus generally preferable to a 2G location determination.

However, as indicated above, the position-finding methods offered by each of the two sub-systems, based on measurements carried out by a dual mode UE, are currently partitioned, to such an extent that the location determination performed is sometimes inaccurate.

An objective of this invention is to offset these disadvantages and improve the accuracy of determining the location of the mobile terminals in a heterogeneous radiocommunication system.

Another objective of the invention is to make use of the position-finding methods provided under the different radiocommunication systems in order to obtain an improved determination of the location based on the methods available.

Thus, the invention proposes a position-finding process in a radiocommunication system that comprises at least one first and one second sub-system, and means for finding the position of a mobile terminal, wherein the mobile system can communicate and carry out measurements relating to position-finding on each of the first and second sub-systems, and the position finding means for locating the mobile terminal are embodied in such a way that they can take into account at least some of the measurements carried out by the mobile terminal. The process comprises the following steps when the mobile terminal is connected to the first sub-system:
measurements relating to position finding on the second sub-system are carried out in the mobile terminal;
the measurements thus carried out are transmitted to the first sub-system; and
implementing the means in order to find the position of the mobile terminal by taking into account at least some of the measurements transmitted to the first sub-system.

This provides for a location determination based on the measurements of the second sub-system and, possibly, also on those of the first sub-system. Thus, the reliability of the position-finding process is improved.

In a beneficial manner, the measurements are carried out at the mobile terminal upon an order from the first sub-system to which the mobile terminal is connected. This order may also be triggered by a position-finding request generated by a client internal or external to the radiocommunication system, which may be the mobile terminal itself, if necessary.

When the mobile terminal is not initially linked to the first sub-system, meaning that it is connected to this sub-system without having any communication in progress with it, and without receiving any signaling channel transmitted by this sub-system, a polling mechanism is implemented in order to generate such link.

For illustration purposes, regarding said first and second sub-systems, one may be a second generation (2G or 2.5G) radiocommunication system, while the other may be a third generation radiocommunication system.

When the first sub-system is capable of processing the measurements carried out on the second sub-system by the mobile terminal, it takes them into account, in a beneficial manner, in its position-finding algorithm, in the same way as any position-finding measurements carried out by the mobile terminal on the first sub-system. This situation could arise, in particular, when the measurements carried out on the second sub-system are consistent with a position-finding method used by the first sub-system.

However, when the first sub-system is not itself capable of processing the measurements carried out on the second sub-system by the mobile terminal, it transmits said measurements to the second sub-system, in a beneficial manner, so that they may be processed thereat according to an appropriate position-finding method. In a beneficial manner, the result of the processing provides position-finding data that are sent back to the first sub-system, so that they may be taken into account in the determination of the location performed by taking into account the measurements carried out by the mobile terminal on the first sub-system.

The invention also proposes a position-finding system for determining the location of a mobile terminal, with the position-finding system arranged so as to enable the implementation of the above-mentioned process.

The invention also proposes a position-finding device for determining the location of a mobile terminal, in a first sub-system of a radiocommunication system that also comprises a second sub-system, with the mobile terminal being capable of communicating and carrying out measurements relating to position-finding on each of the first and second sub-systems. The position-finding device includes, in relation to a mobile terminal connected to the first sub-system:
means for ordering the mobile terminal to carry out position-finding measurements on the second sub-system;
means for receiving the measurements carried out; and
means for finding the position of the mobile terminal.

Other features and advantages of this invention will appear in the following description of implementation examples, which is provided on a non limitative basis, with reference to the attached drawings, where:

FIG. 1, as previously mentioned, is a block diagram of a second generation system capable of implementing a second generation location system;

FIG. 2, as previously mentioned, is a block diagram of a third generation system capable of implementing a third generation location system;

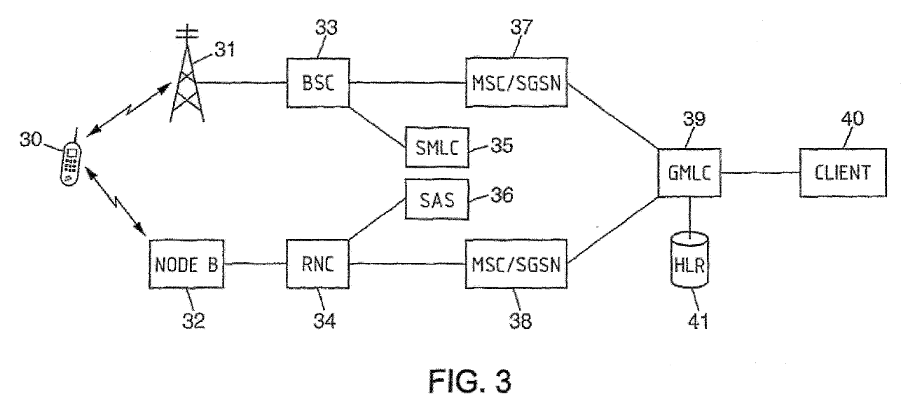

FIG. 3 is a block diagram of a heterogeneous system where this invention may be implemented.

FIG. 3 represents a heterogeneous system that comprises a 2G or 2.5G sub-system and a 3G sub-system. The 2G or 2.5G sub-system includes a BTS 31, connected to a BSC 33, which is itself connected to a core network switch 37 which may consist of a MSC (“Mobile Switching Centre”), if we are in a circuit mode communication context, or a SGSN (“Serving GPRS Support Node”), if we are in a packet mode communication context. The 3G sub-system includes a Node B 32, connected to a RNC 34, which is itself connected to a core network switch 38 that may consist of a MSC or SGSN.

A UE 30 is also capable of communicating with each of the two sub-systems. To this end, a radio link may be established with either the BTS 31, in the 2G case, or the Node B 32, in the 3G case.

The system represented in FIG. 3 also includes position-finding means. These include, in particular, a SMLC 35 connected to the BSC 33, and a SAS 36 connected to the RNC 34. A GMLC (“Gateway Mobile Location Centre”) 39 is also connected to both radiocommunication sub-systems through their respective switches 37 and 38. This GMLC 39 is a platform that constitutes the first access point for an external client 40 requesting the implementation of a location service in one of the sub-systems (note that the location request can also be made by an internal client of the radiocommunication system, which could actually be the mobile terminal 10 itself). It is also connected to the HLR (“Home Location Register”) that includes, in particular, the routing information concerning the UE 30. When a client 40 requests a location of the UE 30, the GMLC may poll the HLR 41 in order to find the location area where the UE 30 is located, if it is not in the process of communicating.

In a first embodiment, the UE 30 is considered to have a connection with the BTS 31, meaning that the UE 30 is in 2G (or 2.5G) mode. This may occur, in particular, when the signal received at the UE 30 from the BTS 31 is greater than the signal received from the Node B 32. A connection between the UE 30 and the BTS 31 means that the UE 30 is either in the process of communicating through the BTS 31, with the communication being carried by a radio channel, or in a mode where it receives the signal from the BTS 31 without any actual communication being in progress. When the UE 30 does not initially have a radio connection, while being connected to the 2G sub-system, it is polled by the latter so that a connection may be established with the BTS 31. This polling may consist, for example, in paging the UE 30 after determining the location area where the UE 30 is located, as indicated above.

In order to take advantage of the larger pass-band of the 3G system, compared to the 2G system, and thus of a greater reliability of the position finding carried out in 3G, a position-finding request from a client 40 may then be performed from the measurements carried out in EG, possibly in addition to the measurements carried out in 2G.

When the client 40 requests a determination of the location of the UE 30, this request is received by the GMLC 39 and forwarded to the SMLC 35, for example, through the MSC/SGSN 37. A. RRLP request is then transmitted from the SMLC 35 to the UE 30, so that the latter may carry out useful measurements for the determination of the location. It arrives at the UE 30 through the radio equipment 33 and 31. This request indicates to the UE 30 that measurements must be carried out on the Nodes B of the 3G sub-system, possibly in addition to the measurements on the BTS of the 3 G sub-system, such as the BTS 31. In response to such request, the UE 30 sends back to the SMLC 35 the measurements carried out on the 3G sub-system, for example from the signals received from the Node B 32. The measurements carried out are of the 3G type and correspond to one of the 3G position-finding methods presented in the introduction. For example, these may be OTDOA type measurements. If the RRLP request transmitted to the UE 30 specifies a specific position-finding method, the measurements carried out by the UE 30 will preferably be consistent with the specified method.

Once that the 3G measurements carried out by the UE 30 are transmitted to the SMLC 35 in response to the RRLP request, that latter processed them in the same manner that a SAS would do it if it had the capability to do so. To this end, the SMLC 35 supports the implementation of a position-finding method corresponding to the 3G measurements carried out. This could be the case, in particular, when a shared location centre is used for the 2G and 3G sub-systems, combining the functions of the SMLC 35 and SAS 36, and thus capable of locating a UE from the 2G, 3G, or combined 2G+3G measurements.

If the SMLC 35 is not itself capable of processing the 3G type measurements, it retransmits them in a beneficial manner to the SAS 36 of the 3G sub-system. This transmission may be carried out directly if a communication interface is available between the SMLC 35 and the SAS 36 (for example, an Lp type interface, as it exists currently between two SMLC, and as described in technical specification TS 48.031, version 5.0.0, “Technical Specification Group GSM EDGE Radio Access Network; Location Services (LCS); Serving Mobile Location Centre—Serving Mobile Location Centre (SMLC-SMLC); SMLCPP specification,” published in July 2002 by the 3GPP), or through the GMLC 39 that is connected to the SMLC 35 and the SAS 36.

The SAS 36 then has 3G type measurements, which it can use in order to implement a 3G position-finding method as presented in the introduction. Thus, it fulfills its role as a calculation server for the determination of the location of the UE 30. The result of such location determination is then returned in a beneficial manner to the SMLC 35 that sub-processed the location calculation based on the 3G measurements, so that it may transmit it to the client 40 that originated the position-finding request, through the GMLC 39. Alternatively, the SAS 36 may return the result of its location calculation directly to the client 40.

When the RRLP request requires both 2G measurements on the 2G sub-system and 3G measurements on the 3G sub-system from the UE 30, these measurements are processed in a beneficial manner by the SMLC 35 or the SAS 36, if either equipment is capable of processing such mixed measurements. This case may arise, in particular, when a unified location centre is used for both the 2G and the 3G sub-systems, and when the 2G and 3G measurements can be taken into account by the same position-finding method implemented by this unified location centre.

Alternatively, the 3G measurements are transmitted to the SAS 36, while the 2G measurements are processed in the SMLC 35. The 3G measurements transmitted to the SAS 36 may be subjected to a first location calculation. It is then beneficial to transmit the result of such calculation to the SMLC 35, so that it may complete it from the measurements carried out on the 2G sub-system. This provides two location results, obtained from methods that may be different. These results can then be combined (for example, by averaging the results using the reliability of each position-finding method used as a weighting factor) in order to provide an improved position-finding information to the client 40.

We will now consider the other hypothetical case where the UE 30 is radio linked to the Node B 32. This may occur, in particular, when the signal received at the UE 30 from the Node B 32 is greater than the signal received from the BTS 31. A communication is then in progress on the 3G infrastructure, or the UE 30 is receiving a signal from the 3G sub-system. As in the case described above, if such link does not exist, the UE 30 is polled in order to establish such link, for example by paging, in order to order the UE 30 to carry out the location measurements.

For example, in order to take advantage of the greater density of base stations of the 2G sub-system compared to the 3G sub-system, a location determination requested by a client 40 may be performed by applying a 2G position-finding method, from the 2G measurements, which may the be completed by 3G type measurements.

The request from the client 40 is thus transmitted to the GMLC 39, which forwards it to the RNC 34. The latter then sends a RRC message to the UE 30, through the Node B 32, ordering it to carry out measurements that may be used in a 2G position-finding method, possibly in addition to the 3G type measurements. The 2G measurements carried out by the UE 30 may be of a type specified in the RRC request, such as OTD measurements, for example.

Once that the measurements requested have been carried out by the UE 30, the latter sends them back to the RNC 34, which can then transfer the measurements to the SAS 36 through a PCAP interface, so that the SAS may implement a position-finding method that takes into account the 2G measurements carried out. When 3G type measurements carried out and transmitted by the UE 30 are also available at the RNC 34, said measurements are taken into account, in a beneficial manner, in the location calculation performed by the SAS 36, in order to complete the 2G type measurements.

In a manner similar to the previous case, the SMLC 35 may be used to determine a location based on the measurements carried out on the 2G sub-system, if the SAS 36 is not itself capable of performing the calculation, for example due to the fact that the position-finding methods implemented by the SAS 36 do not use the 2G measurements such as those transmitted by the UE 30 as input parameters. The location determination is then performed by the SMLC 35 according to a 2G position-finding method that corresponds to the type of measurements carried out. It may also be completed by a location determination based on measurements carried out on the 3G sub-system, which is entrusted in a beneficial manner to the SAS 36 by the RNC 34.

The final location determination, which may be that which has been determined on either of the 2G or 3G systems, or according to a combination of the results obtained for each of these sub-systems, is then transmitted to the GMLC 39, so that it may communicate it to the client 40 originating the request.

Although this invention has been described in more detail in relation to the example of a heterogeneous radiocommunication system comprising a 2G or 2.5G sub-system and a 3G sub-system, it shall be understood that it may also be implemented in any heterogeneous radiocommunication system comprising at least two sub-systems that give rise to location calculations that differ in terms of reliability.

1. Position-finding process in a radiocommunication system that comprises at least one first and one second sub-system, and means for finding the position of a mobile terminal, wherein the mobile system can communicate and carry out measurements relating to position-finding on each of the first and second sub-systems, and the position finding means for locating the mobile terminal are embodied in such a way that they can take into account at least some of the measurements carried out by the mobile terminal, the process comprising the following steps when the mobile terminal is connected to the first sub-system:
measurements relating to position finding on the second sub-system are carried out in the mobile terminal;
the measurements thus carried out are transmitted to the first sub-system; and
implementing the means in order to find the position of the mobile terminal by taking into account at least some of the measurements transmitted to the first sub-system.

2. Process according to claim 1, where the measurements related to the location are carried out on the second sub-system, at the mobile terminal, upon the order from the first sub-system.

3. Process according to claim 1, where the measurements related to the location are carried out, at the mobile terminal, on the second sub-system, upon the request from a client.

4. Process according to claim 2, comprising a preliminary step involving the polling of the mobile terminal, when the mobile terminal is not connected to the first sub-system.

5. Process according to claim 1, where the measurements related to the location are also carried out, at the mobile terminal, on the first sub-system, with said measurements being transmitted to the first sub-system, and where the implementation of the means for finding the location of the mobile terminal also take into account at least some of said measurements carried out on the first sub-system.

6. Process according to claim 1, where each of the first and second sub-systems include means for locating a mobile terminal from the location measurements carried out by the mobile terminal on the corresponding sub-system, and where the measurements carried out by the terminal on the second sub-system are also transmitted to the second sub-system from the first sub-system, and where the implementation of the means for finding the location of the mobile terminal, by taking into account at least some of the measurements transmitted, includes the implementation of the means of the second sub-system in order to find the location of the mobile terminal by taking into account at least some of the measurements carried out by the mobile terminal on the second sub-system.

7. Process according to claim 6, where the location measurements are also carried out, at the mobile terminal, on the first sub-system, with said measurements being transmitted to the first sub-system, where the result provided by the means of the second sub-system for finding the location of the mobile terminal is transmitted to the means of the first sub-system, by taking into account at least some of the measurements carried out on the first sub-system and the result provided by the means of the second sub-system.

8. Process according to claim 1, where, with regard to said first and second sub-systems, one is a second generation radiocommunication system and the other is a third generation radiocommunication system.

9. Position-finding system for determining the location of a mobile terminal, where the position-finding system is arranged so as to enable the implementation of the process according to claim 1.

10. Position-finding system for determining the location of a mobile terminal, in a first sub-system of a radiocommunication system that also comprises a second sub-system, with the mobile terminal being capable of communicating and carrying out measurements relating to position-finding on each of the first and second sub-systems, where the position-finding device includes, in relation to a mobile terminal connected to the first sub-system:
means for ordering the mobile terminal to carry out position-finding measurements on the second sub-system;
means for receiving the measurements carried out; and
means for finding the position of the mobile terminal.

11. Position-finding device according to claim 10, which also comprises means for ordering the mobile terminal to carry out position-finding measurements on the first sub-system, means for receiving the measurements carried out by the mobile terminal on the first sub-system, and where the means for finding the position of the mobile terminal take into account at least some of the measurements carried out by the mobile terminal on the first sub-system.

12. Position-finding device according to claim 10, where the means for finding the position of the mobile terminal take into account at least some of the measurements carried out by the mobile terminal on the second sub-system, and received by the means for receiving said measurements carried out.

13. Position-finding device according to claim 10, comprising means for transmitting to the second sub-system the measurements carried out by the mobile terminal on the second sub-system, and received by the means for receiving said measurements carried out.

14. Position-finding device according to claim 13, comprising means for receiving the position-finding information from the second sub-system, and where the means for finding the position of the mobile terminal take into account at least some of said position-finding information received from the second sub-system.

15. Position-finding device according to claim 10, where the means for ordering the mobile terminal to carry out the position-finding measurements are implemented upon the request from a client.

16. Position-finding device according to claim 10, where, with regard to said first and second sub-systems, one is a second generation radiocommunication system and the other is a third generation radiocommunication system.
